(19) United States
(12) Patent Application Publication
(10) Pub. No.: US 2018/0224581 A1
(43) Pub. Date: Aug. 9, 2018

(54) LENTICULAR STRUCTURE

(71) Applicant: ASAHI GLASS COMPANY, LIMITED, Chiyoda-ku (JP)

(72) Inventors: Kosuke TAKAYAMA, Chiyoda-ku (JP); Yuki Kondo, Chiyoda-ku (JP)

(73) Assignee: ASAHI GLASS COMPANY, LIMITED, Chiyoda-ku (JP)

(21) Appl. No.: 15/943,747

(22) Filed: Apr. 3, 2018

Related U.S. Application Data
(63) Continuation of application No. PCT/JP2016/083864, filed on Nov. 15, 2016.

(30) Foreign Application Priority Data
Nov. 16, 2015 (JP) 2015-223749

(51) Int. Cl. G02B 3/06; G02B 3/00; F21V 8/00

(52) U.S. Cl. CPC G02B 3/06; G02B 6/0035; G02B 3/005; G02B 3/0031

(57) ABSTRACT

To provide a lenticular structure having a lenticular lens having a high size accuracy and formed on the entire main surface of a light guide plate, which includes the vicinity of an end surface.

A lenticular structure including a lenticular lens in which a plurality of cylindrical lenses linearly extending are arranged in parallel in one direction on at least one main surface of a glass light guide plate main body having a rectangular shape in plan view, wherein the cylindrical lenses are cured products of a UV curable resin, the light guide plate body has a plate thickness deviation (TTV) value of at most 0.2 mm, the amount of curvature in each side direction of the rectangle is at most 0.6 mm, and the difference in length between two opposing sides is within 2.5 mm.

### TECHNICAL FIELD

The present invention relates to a lenticular structure including on one main surface, a lenticular lens. The lenticular structure of the present invention is suitable as a light guide plate for an edge-light type backlight.

### BACKGROUND ART

Heretofore, a liquid crystal display device has been used for mobile phones, PDAs, liquid crystal televisions, etc. A backlight in the liquid crystal display device may be a direct type or an edge-light type. The edge-light type is suitable for increase in the size and reduction in the thickness of the screen of the liquid crystal display device, since light sources are disposed at a side surface in a direction at right angles to the display surface of the liquid crystal display device.

In the case of a liquid crystal display device using an edge-light type backlight, dynamic contrast can be increased by combining a local dimming technique. Further, by forming a lenticular lens on a light-emitting surface of a light guide plate, the beam spread of light from LED which is a light source is improved, and the display properties employing the local dimming can be improved (Patent Document 1).

As a light guide plate for an edge-light type backlight, it has been studied to use a light guide plate made of a glass material as a material having a higher heat resistance and of which the thermal expansion is smaller than light guide plates made of a resin material (Patent Document 2). As a method for forming a lenticular lens on a surface of a light guide plate, there is an example of forming a lenticular lens using a material which is different from a light guide plate made of a resin material (Patent Document 3). On the other hand, an example has not been known that forming a lenticular lens on a surface of a light guide plate made of a glass material is studied in detail.

In recent years, the demand for narrowing the frame of the liquid crystal display device has increased, and it has been desired to form a lenticular lens to the vicinity of the end surface of a light guide plate so that the vicinity of the end surface of the light guide plate in an edge-light type backlight can also be used as a display area.

On the other hand, the end surface of the light guide plate in the edge-light type backlight is required to have functions as an incidence plane and a reflection plane for light, and thereby it is required to maintain the shape of the end surface of the light guide plate formed by cutting or polishing.

### PRIOR ART DOCUMENTS

### Patent Documents

Patent Document 1: JP-A-2013-127966

Patent Document 2: JP-A-2009-199875

Patent Document 3: JP-A-2007-311325

### DISCLOSURE OF INVENTION

### Technical Problem

It is an object of the present invention to provide a lenticular structure wherein (1) a lenticular lens is formed on the entire main surface including the vicinity of an end surface of a light guide plate made of a glass material and (2) the end surface of the light guide plate made of a glass material will not be stained with a material for forming the lenticular lens.

### Solution to Problem

In order to accomplish the above object, the present invention provides a lenticular structure including a lenticular lens in which a plurality of cylindrical lenses linearly extending are arranged in parallel in one direction on at least one main surface of a glass light guide plate main body having a rectangular shape in plan view, wherein the cylindrical lenses are cured products of a UV curable resin, the light guide plate body has a plate thickness deviation (TTV) value of at most 0.2 mm, the amount of curvature in each side direction of the rectangle is at most 0.6 mm, and the difference in length between two opposing sides is within 2.5 mm.

In the lenticular structure of the present invention, on the main surface, the distance between the end surface of the lenticular lens and the closest end surface of the light guide plate body is preferably more than 0 mm and at most 5 mm.

Further, in the lenticular structure of the present invention, in each arc in a vertical cross section of the lenticular lens, the variation in height relative to the main surface of the arc (Δh/hₐᵥ×100) is preferably at most 10%, where h is the maximum height to the main surface of each arch, hₐᵥ is the average value of h, and Δh is the difference between the maximum value hₘₐₓ and the minimum value hₘᵢₙ in h. FIG. 2B is a schematic figure in a case of four cylindrical lenses as one example, and h's relative to four arcs are represented by h₁, h₂, h₃ and h₄ respectively.

### Advantageous Effects of Invention

A liquid crystal display device having a narrow frame and a high dynamic contrast can be realized by using the lenticular structure of the present invention as a light guide plate in an edge-light type backlight.

### BRIEF DESCRIPTION OF DRAWINGS

FIG. 1: FIG. 1(A) is a schematic plane view of the lenticular structure of the present invention as one example, and FIG. 1(B) is a schematic cross-sectional view of a-a line of FIG. 1(A).

FIG. 2: FIG. 2(A) is an enlarged schematic view of FIG. 1(B). FIG. 2(B) is an enlarged schematic view in a case of four cylindrical lenses.

FIG. 3: FIG. 3 is a similar figure to FIG. 2 and is a schematic view of the lenticular structure of the present invention as another example.

FIG. 4: FIG. 4 is a view illustrating a distance between the end surface of the lenticular lens and the closest end surface of the light guide plate body made of a glass material as one example.

### DESCRIPTION OF EMBODIMENTS

Now, the lenticular structure of the present invention will be described with reference to the drawings.

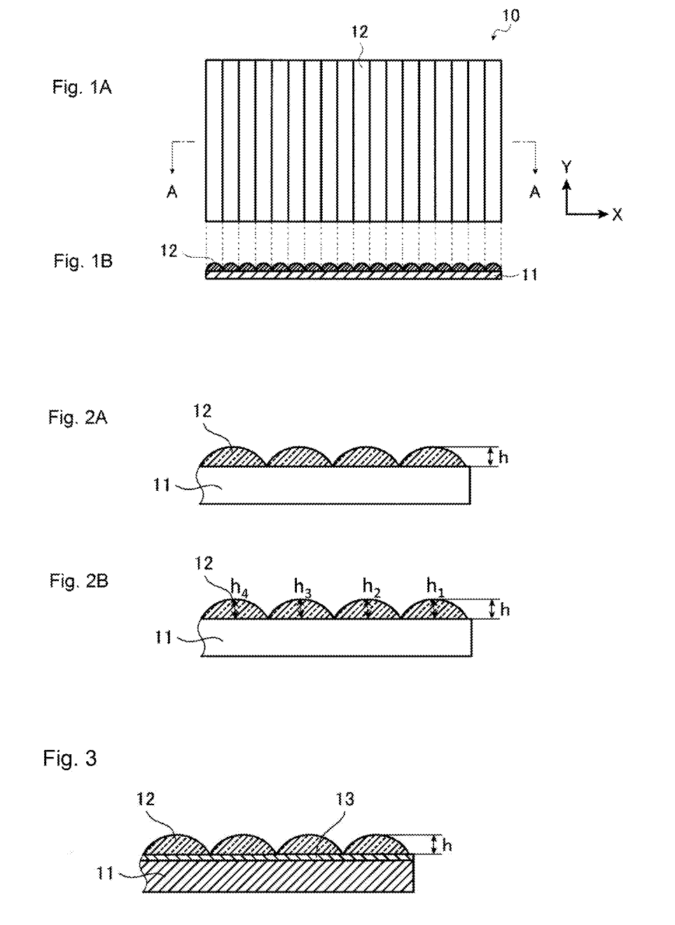

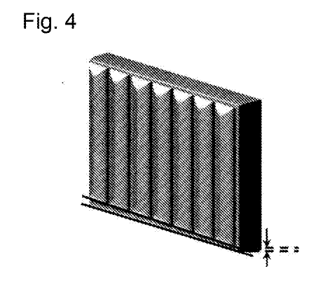

The lenticular structure 10 illustrated in FIGS. 1(A) and (B) comprises a light guide plate body 11 and a lenticular lens 12 formed on the main surface of the light guide plate body 10. Here, the lenticular lens 12 is a lens in which a plurality of cylindrical lenses (cylindrical lenses of which one surface has plane shape) linearly extending are arranged in parallel in one direction. The cylindrical lenses may be formed so as to extend in straight lines and to be arranged substantially parallel in any side of the light guide plate body 11, or as a case requires, may be formed so as to extend in straight lines in a direction having a predetermined angle to a specific side. In the lenticular lens 12 illustrated in FIG. 1(A), cylindrical lenses extending in straight lines toward a Y axis are arranged parallel in one direction (X axis direction) perpendicular to the Y axis direction. Here, the cylindrical lens is a lens of which at least one surface is a cylindrical surface, namely a lens having a surface having curvature in one direction and having no curvature in a direction perpendicular to said one direction. Thus, the cross-sectional view of the lenticular lens is usually arc.

The end surface of the lenticular structure 10 has an end surface of the light guide plate body 11 and an end surface of a lenticular lens 12. The end surface of the lenticular lens 12 is an end surface of a cured product of a UV curable resin material at an interference between a region where the cured product of the UV curable resin material constituting the lenticular lens exists and a region where it does not exist on the light guide plate body 11. From the viewpoint of preventing the end surface of the light guide plate body 11 from being stained with the UV curable resin material constituting the lenticular lens, when the end surface of the light guide plate body 11 and the end surface of the lenticular lens 12 are on the same plane surface, the efficiency to utilize light from a light source is made to be high. However, they may be on different planes, so far as the efficiency to utilize light from a light source will not be low. Further, from the viewpoint of taking the after-described error in the shape of the light guide plate body 11, the error in coating, etc. into consideration, the end surface of the light guide plate body 11 and the end surface of the lenticular lens 12 may not be parallel, so far as the efficiency to utilize light from a light source will not be low. When the end surface of the light guide plate body 11 and the end surface of the lenticular lens 12 are substantially parallel, an effective region as a backlight at the time of incorporating a lenticular structure in a liquid crystal display device increases, which leads to the improvement of the brightness, such being preferred.

Here, the light guide plate body 11 comprises a glass plate of which a planar shape is rectangular in a plane view (rectangular in a plane view). Thus, the light guide plate body 11 has two main surfaces, a lenticular lens 12 may be formed on an either surface of these two main surfaces, and lenticular lenses 12 may be formed on both main surfaces.

Here, in the rectangular shape in plane view of the light guide plate body 11, the difference in length of two opposite sides in the after-mentioned range is permissible.

The lenticular lens on the light guide plate made of a glass material is made of a different material from the light guide plate body. As a method for a light guide plate made of a resin material, there is a method of applying a UV curable resin material on a light guide plate body or pasting a sheet form UV curable resin material to a light guide plate body, and then pressing on a roll mold and transferring a lenticular shape formed on a surface of the mold, followed by UV curing. Further, as another method, there is a method of coating a surface of a roll mold with a solution of a UV curable resin material and applying UV from the light guide plate body side, while the light guide plate body is made to be in contact with the coating surfaced.

The light guide plate made of a glass material has a higher elastic modulus than light guide plates made of a resin material, and thereby the light guide plate body has little cushion effect such that when the light guide plate body is pressed on a mold, even force or heat is applied, the light guide plate body is hardly deformed. Thus, if the light guide plate body has slight unevenness in its shape or size, when applying any of the above described methods to the light guide plate made of a glass material, it is difficult to contact the entire surface of the light guide plate body on a mold. If the light guide plate body has a high elastic modulus, it may be possible to induce the deformation of the light guide plate body by strongly pressing the light guide plate body on a mold. However, in such a case, the light guide plate body strongly contacts to the mold. The glass material has a high surface hardness than the resin material, and thereby the mold may be damaged or worn, or the light guide plate body made of a glass material may be cracked.

Further, in a case where the entire surface of the light guide plate body cannot be in contact with a mold, the size accuracy and the shape accuracy of a lenticular lens to be formed on the light guide plate body may deteriorate, and a lenticular lens itself may not be formed on a part which is not in contact with the mold.

The lenticular lens 12 is made of a cured product of a UV curable resin material. Thus, by the above-described method of forming a lenticular lens on the main surface of a light guide plate body by means of a mold, the lenticular lens 12 may be formed on the main surface of the light guide plate body 11.

In a case where a lenticular lens is formed on a surface of a light guide plate by means of the above-described mold, it is difficult to satisfy both the above-mentioned requirements (1) and (2) due to the slight unevenness in the shape and size of the light guide plate body. However, in the present invention, as the light guide plate body 11, one having extremely little unevenness in the shape and size is selected as described below, whereby both the above-mentioned requirements (1) and (2) can be satisfied.

The light guide plate body 11 of the present invention has a plate thickness deviation (TTV) value of at most 0.2 mm. The plate thickness deviation (TTV) of the light guide plate body 11 is obtained by flatly placing the light guide plate body 11 on a surface plate with the main surface on which a lenticular lens is to be formed facing upward, horizontally moving a contact type displacement sensor (for example high accuracy contact type digital sensor GT2, manufactured by KEYENCE CORPORATION) on the light guide plate body 11 to measure displacement distribution and calculating the difference between the maximum value and the minimum value in the displacement distribution. Here, the surface plate is preferably a stage on which the light guide plate body 11 is placed in a device to be actually used for forming a lenticular lens 12. Further, the measurement may be simply and accurately carried out by coating the contact type displacement sensor with a UV curable resin material at the time of forming a lenticular lens 12 or incorporating the contact type displacement sensor into a drive mechanism at the time of contacting a mold.

The light guide plate body 11 of the present invention preferably has a plate thickness deviation (TTV) value of at most 0.15 mm, more preferably at most 0.12 mm.

The light guide plate body 11 of the present invention has a warp amount in each side direction of the rectangle of at most 0.6 mm. In the light guide plate body 11 illustrated in FIG. 1(A), warpage may be formed in both X direction and Y direction. The light guide plate body 11 of the present invention has a warp amount of at most 0.6 mm in X direction and also has a warp amount of at most 0.6 mm in Y direction in FIG. 1(A). Further, the warp amount of the light guide plate body 11 can be measured by a commercial available warpage measuring apparatus for a glass substrate (for example, glass plate contactless strain warpage measuring apparatus, manufactured by Ohmiya Industry Co., Ltd.). As an apparatus for measuring warpage, one having a contactless sensor or a laser positioning meter is preferred.

The light guide plate body 11 of the present invention preferably has a warp amount of at most 0.5 mm, more preferably at most 0.4 mm.

In the light guide plate body 11 of the present invention, the difference in length between two opposing sides is within 2.5 mm. In the light guide plate body 11 illustrated in FIG. 1(A), the up and down two sides are two opposing sizes, and the left and right two sides are corresponding two sides. In the light guide plate body 11 of the present invention, both the difference in length between the up and down two sides and the difference in length between the left and right two sides are within 2.5 mm in FIG. 1(A).

Here, the length of each side of the light guide plate body 11 can be measured by inserting the light guide plate body 11 between contact type measuring sensors installed so as to oppose each other in accordance with the same procedure described in WO2009/119772 at FIG. 1 and paragraphs 0024 to 0026. The measuring sensors are installed so as to be in a position at 10 mm from a corner part of the light guide plate body 11 to measure.

In the light guide plate body 11 of the present invention, the difference in length between two opposing sides is preferably at most 1.0 mm, more preferably at most 0.5 mm, particularly preferably at most 0.35 mm.

The light guide plate body 11 of the present invention has the value of the plate thickness deviation (TTV), the amount of curvature and the difference in length between two corresponding sides within the above ranges, whereby when forming a lenticular lens on the main surface of the light guide plate body 11 by means of a mold, the entire main surface of the light guide plate body 11 is made to be in contact with the mold successfully. Thus, a lenticular lens can be formed on the entire main surface of the light guide plate body 11 including the vicinity of the end surface.

Further, when coating the main surface of the light guide plate body 11 with a UV curable resin material by die coating, blade coating, bar coating or inkjet coating so that a lenticular lens would be formed on the entire main surface of the light guide plate body 11 including the vicinity of an end surface, the entire main surface of the light guide plate body 11 can be successfully in contact with the mold, whereby by strictly controlling the range to be coated, the end surface of the light guide plate body 11 is free from being stained with a stray coating liquid. Further, even in a case where a mold side is coated with a UV curable resin material, an excess liquid will not attach on the end surface of the light guide plate body 11. The following advantageous are thereby obtained.

Particularly, when processing the end surface of the lenticular structure 10, various adjustments are required in a step of cutting laminated different materials and polishing an end surface to be formed by cutting, since the glass material constituting the light guide plate body has a different elastic modulus from the resin material constituting the lenticular lens. Thus, in the case of the light guide plate made of a glass material, the light guide plate body is preliminarily cut into a size of a final product, and a lenticular lens is preferably formed on a surface of the light guide plate body of which an end surface is polished. In such a case, in order to satisfy the above requirement (1), it is preferred to precisely control the range to be coated with a coating solution to the vicinity of the end surface of the light guide plate body. That is, it is preferred to control the range to be coated so as not to stain the end surfaces of the light guide plate body, even though a coating solution strays from the range to be coated.

Here, if one or two of the value of the plate thickness deviation (TTV), the amount of curvature and the difference in length between two opposing sides in the above ranges are merely satisfied, it is difficult to produce a lenticular lens having the predetermined shape without problems, while preventing a coating liquid from straying.

In the present invention, in a case where a lenticular lens is formed on the entire main surface of the light guide plate body 11 including the vicinity of an end surface, the distance between the end surface of the lenticular lens and the closest end surface of the light guide plate body 11 to the lenticular lens is made to be from more than 0 mm to at most 5 mm, preferably from more than 0 mm to at most 3 mm, more preferably form more than 0 mm to at most 1 mm. The distance between the end surface of the lenticular lens and the closest end surface of the light guide plate body 11 to the end surface of the lenticular lens may be measured by a method such as the stylus profiling system (for example, Dektak, manufactured by Bruker Corporation) or the measurement by means of an optical microscope.

Further, at the time of forming a lenticular lens on the main surface of the light guide plate body 11 of the present invention by means of a mold, the entire main surface of the light guide plate body 11 is made to be successfully in contact with the mold, whereby the size accuracy of the lenticular lens 12 to be formed on the main surface of the light guide plate body 11 is high. As the index of the size accuracy of the lenticular lens 12 to be formed on the main surface of the light guide plate body 11 in the present invention, the deviation in height of cylindrical lenses constituting the lenticular lens 12 may be used. Here, as illustrated in FIG. 2, the maximum height h of the arc included in the vertical cross-section of each cylindrical lens constituting the lenticular lens 12 from the main surface of the light guide plate body 11 is used as the standard of the height of the cylindrical lenses constituting the lenticular lens 12. Here, the variation in the height of the arc h is represented by the following formula:

the variation in the height of the arc h (%)=Δh/hₐᵥ×100 where hₐᵥ is the average value of the above h of all cylindrical lenses constituting the lenticular lens 12, and in the above h of all cylindrical lenses constituting the lenticular lens 12, Δh is the difference between the maximum value hₘₐₓ and the minimum value hₘᵢₙ.

In the present invention, the variation in the height of the arc “h” is made to be at most 10%. The variation in the height of the arc “h” is preferably at most 7%, more preferably at most 5%, from the viewpoint of the in-plane uniformity of the amount of light emitted from the lenticular structure.

Here, the height of the arch “h” may be appropriately set depending on the resolution (cell pitch), the view angle, etc. of a liquid crystal display device in which the lenticular structure is used as an edge light type backlight, similarly to lenticular lenses to be used as an edge light type backlight in non-liquid crystal display devices. The height of the arch “h” may, for example, be from 10 to 250 μm, however, the height of the arch “h” is by no means restricted thereto.

As illustrated in FIG. 3, the lenticular lens 12 may be formed on a resin layer 13 formed on the entire main surface of the light guide plate body 11. The resin layer 13 is an underlayer which is formed at the time of forming a lenticular lens 12 on the main surface of the light guide plate body 11 and made of the same material as the lenticular lens 12. In such a case, the above h is the maximum height of the arc contained in the cross-section of each cylindrical lens constituting the lenticular lens 12 from the surface of the resin layer 13. The thickness of the resin layer 13 may be an optional thickness and is preferably at least 20% of hₐᵥ. The thickness of the resin layer 13 is preferably at most 200% of hₐᵥ.

The above effect can be preferably obtained, even in a case where a lenticular lens is not formed at the vicinity of the end surface in the main surface of the light guide plate body 11. In such a case, the distance between the end surface of the lenticular lens on the main surface of the light guide plate body 11 and the closest end surface of the light guide plate body 11 to the lenticular lens is more than 0 mm and at most 5 mm, preferably more than 0 mm and at most 3 mm, more preferably more than 0 mm and at most 1 mm.

Now, the lenticular structure of the present invention will be further described.

### Light Guide Plate Body

The glass plate having a rectangular shape in plane view and constituting the light guide plate body is preferably a glass plate having a high internal transmittance to light in the visible light range (from 380 to 780 nm) and made of a multiple component oxide glass such as soda lime silicate glass, aluminosilicate glass, borate glass, lithium aluminosilicate glass, borosilicate glass or alkali free glass, since the lenticular structure of the present invention is used as a light guide plate body for an edge-light type backlight. Further, the reason why the glass plate made of a multicomponent oxide glass is used is that it is easily melted and suitable for mass production.

In production of the multiple component oxide glass, iron is blended in the glass material so as to improve melting properties of the glass. However, iron has absorption in the visible light range, and accordingly, if the iron content is high, the internal transmittance in the visible light region deteriorates.

In the multiple component oxide glass to be used as the light guide plate body 11, the total content of iron is preferably at most 100 mass ppm for suppressing the deterioration of the internal transmittance in the visible light region, more preferably at most 80 mass ppm for obtaining extremely high transmittance in the entire visible light region, more preferably at most 60 mass ppm, further preferably at most 45 ppm, further preferably at most 40 mass ppm, furthermore preferably at most 30 mass ppm, furthermore preferably at most 25 mass ppm, particularly preferably at most 20 mass ppm. On the other hand, the total content of iron in the multiple component oxide glass to be used as the light guide plate body 11 is preferably at least 5 mass ppm for improving the melting property of glass in the production of the multiple component oxide glass, more preferably at least 8 mass ppm, further preferably at least 10 mass ppm. Here, the total content of iron in the multiple component oxide glass to be used as the light guide plate body 11 can be controlled by the amount of iron to be added at the time of producing glass.

Here, the total iron content in the multiple component oxide glass is represented as the amount of Fe₂O₃, however, not all the iron present in the glass is present as Fe³⁺ (trivalent iron). Usually, in glass, Fe³⁺ and Fe²⁺ (bivalent iron) are simultaneously present. Fe²⁺ and Fe³⁺ have absorption in the visible light region, however, the absorption coefficient (11 cm⁻¹ Mol⁻¹) of Fe²⁺ is an order of magnitude greater than the absorption coefficient (0.96 cm⁻¹ Mol-¹) of Fe³⁺, and accordingly Fe²⁺ significantly decreases the internal transmittance in the visible light region. Accordingly, a low content of Fe²⁺ is preferred with a view to increasing the internal transmittance in the visible light region.

The content of Fe²⁺ in the multiple component oxide glass to be used as the light guide plate body 11 is preferably at most 20 mass ppm for improving the internal transmittance in the visible light region, more preferably at most 10 mass ppm, further preferably at most 8 ppm, furthermore preferably at most 5 mass ppm, furthermore preferably at most 4.5 ppm, more preferably at most 4 ppm, particularly preferably at most 3.5 ppm. On the other hand, the content of Fe²⁺ is preferably at least 0.01 mass ppm for improving the melting property of glass at the time of producing the multiple component oxide glass, more preferably at least 0.05 mass ppm, further preferably at least 0.1 mass ppm.

Here, the content of Fe²⁺ in the multiple component oxide glass to be used as the light guide plate body 11 may be adjusted by the amount of an oxidizing agent added in production of glass, the melting temperature, etc. Specific oxidizing agents added in production of glass and their addition amount will be described hereinafter.

Specific examples of the preferred composition of the multiple component oxide glass to be used as the light guide plate body 11 will be described below.

As one example of the constitution (constitution example A) of the multiple component oxide glass to be used as the light guide plate body 11 comprises, as represented by mass percentage based on oxides, from 60 to 80% of SiO₂, from 0 to 7% of Al₂O₃, from 0 to 10% of MgO, from 0 to 20% of CaO, from 0 to 15% of SrO, from 0 to 15% of BaO, from 3 to 20% of Na₂O, from 0 to 10% of K₂O and from 5 to 100 mass ppm of Fe₂O₃.

As another example of the constitution (constitution example B) of the multiple component oxide glass to be used as the light guide plate body 11 comprises, as represented by mass percentage based on oxides, from 45 to 80% of SiO₂, more than 7% and at most 30% of Al₂O₃, from 0 to 15% of B₂O₃, from 0 to 15% of MgO, from 0 to 6% of CaO, from 0 to 5% of SrO, from 0 to 5% of BaO, from 7 to 20% of Na₂O, from 0 to 10% of K₂O, from 0 to 10% of ZrO₂ and from 5 to 100 mass ppm of Fe₂O₃.

As still another example of the constitution (constitution example C) of the multiple component oxide glass to be used as the light guide plate body 11 comprises, as represented by mass percentage based on oxides, from 45 to 70% of SiO₂, from 10 to 30% of Al₂O₃, from 0 to 15% of B₂O₃, from 5 to 30% in total of MgO, CaO, SrO and BaO, at least 0% and less than 3% in total of Li₂O, Na₂O and K₂O and from 5 to 100 mass ppm of Fe₂O₃.

The composition range of each component of the above-mentioned constitution examples A to C will be described below. Further, the unit of the content of each composition is always represented by mass percentage based on oxides or mass ppm, and they are simply represented by “%” or “ppm”.

SiO₂ is a main component of glass. In order to maintain the weather resistance and the devitrification property of glass, the content of SiO₂ is, in the constitution example A preferably at least 60%, more preferably at least 63%, in the constitution example B preferably at least 45%, more preferably at least 50%, and in the constitution example C preferably at least 45%, more preferably at least 50%.

On the other hand, in order to facilitate resolution to make foam quality to be good and also to control the content of divalent iron (Fe²⁺) in glass to be low to make optical properties to be good, the content of SiO₂ is, in the constitution example A preferably at most 80%, more preferably at most 75%, in the constitution example B preferably at most 80%, more preferably at most 70%, and in the constitution example C preferably at most 70%, more preferably at most 65%.

Al₂O₃ is, in the constitution examples B and C, an essential component for improving the weather resistance of the glass. In order to maintain the weather resistance practically required, the content of Al₂O₃ is, in the constitution example A preferably at least 1%, more preferably at least 2%, in the constitution example B preferably more than 7%, more preferably at least 10%, and in the constitution example C preferably at least 10%, more preferably at least 13%.

However, in order to control the content of divalent iron (Fe²⁺) to be low, to make optical properties to be good and to make foam quality to be good, the content of Al₂O₃ is, in the constitution example A, preferably at most 7%, more preferably at most 5%, in the constitution example B, preferably at most 30%, more preferably at most 23%, and in the constitution example C, preferably at most 30%, more preferably at most 20%.

B₂O₃ is a component to facilitate melting of glass raw materials and to improve mechanical properties and weather resistance, but in order to avoid troubles such as formation of striae (ream), erosion of the furnace wall, etc. due to volatilization, the content of B₂O₃ is, in the glass A, is preferably at most 5%, more preferably at most 3%, and in the constitution examples B and C, preferably at most 15%, more preferably at most 12%.

Alkali metal oxides such as Li₂O, Na₂O and K₂O are components which facilitate melting of the glass raw material, and which are useful to adjust thermal expansion, viscosity, etc.

Therefore, the content of Na₂O is, in the glass constitution example A, preferably at least 3%, more preferably at least 8%. In the constitution example B, the content of Na₂O is preferably at least 7%, more preferably at least 10%. However, in order to maintain the clarity upon dissolution, and to maintain the foam quality of the glass to be produced, the content of Na₂O is, in the glass constitution examples A and B, preferably at most 20%, more preferably at most 15%, and in the constitution example C, preferably at most 3%, more preferably at most 1%.

Further, the content of K₂O is, in the glass constitution example A and B, preferably at most 10%, more preferably at most 7%, and in the constitution example C, preferably at most 2%, more preferably at most 1%.

Further, Li₂O is an optional component, but in order to facilitate vitrification, to control the iron content contained as an impurity derived from raw materials to be low and to reduce the batch cost, Li₂O may be contained in an amount of at most 2% in the constitution examples A, B and C.

Further, the total content of these alkali metal oxides (Li₂O+Na₂O+K₂O) is, in order to maintain the clarity upon dissolution and to maintain the foam quality of glass to be produced, in the glass constitution example A and B, preferably from 5 to 20%, more preferably from 8 to 15% and in the constitution example C, preferably from 0 to 2%, more preferably from 0 to 1%.

Alkaline earth metal oxides such as MgO, CaO, SrO and BaO are components which facilitate melting of glass raw materials and which are useful to adjust thermal expansion, viscosity, etc.

MgO has an effect to lower the viscosity at the time of glass melting and to facilitate dissolution. Further, it has an effect to reduce the specific gravity and to make a glass plate to be less susceptible to flaws, and therefore, it may be contained in the constitution examples A, B and C. Further, in order to control the thermal expansion coefficient of glass to be low, and to bring the devitrification property to be good, the content of MgO is, in the constitution example A, preferably at most 10%, more preferably at most 8%, in the constitution example B, preferably at most 15%, more preferably at most 12%, and in the constitution example C, preferably at most 10%, more preferably at most 5%.

CaO is a component to facilitate melting of glass raw materials and also to adjust viscosity, thermal expansion, etc., and therefore, may be contained in the constitution examples A, B and C. In order to obtain the above-mentioned effects, in the glass constitution example A, the content of CaO is preferably at least 3%, more preferably at least 5%. Further, in order to improve the devitrification, it is, in the constitution example A, preferably at most 20%, more preferably at most 10%, and in the constitution example B, preferably at most 6%, more preferably at most 4%.

SrO has an effect to lower the increase of the thermal expansion coefficient and the high temperature viscosity of glass. In order to obtain such effects, SrO may be contained in the constitution examples A, B and C. However, in order to control the thermal expansion coefficient of the glass to be low, the content of SrO is, in the constitution examples A and C, preferably at most 15%, more preferably at most 10%, and in the constitution example B, preferably at most 5%, more preferably at most 3%.

BaO has, like SrO, an effect to lower the increase of the thermal expansion coefficient and the high temperature viscosity of the glass.

In order to obtain such effects, BaO may be contained. However, in order to control the thermal expansion coefficient of glass to be low, the content of BaO is, in the constitution examples A and C, preferably at most 15%, more preferably at most 10%, and in the constitution example B, preferably at most 5%, more preferably at most 3%.

Further, the total content of these alkaline earth metal oxides (MgO+CaO+SrO+BaO), is, in order to control the thermal expansion coefficient to be low, to adjust the devitrification characteristics to be good, and to maintain the strength, in the constitution example A, preferably from 10% to 30%, more preferably from 13% to 27%, in the constitution example B, preferably from 1% to 15%, more preferably from 3% to 10%, and in the constitution example C, preferably from 5% to 30%, more preferably from 10% to 20%.

In the glass composition of the multicomponent oxide glass to be used as the light guide plate body 11, in order to improve the heat resistance and surface hardness of the glass, ZrO₂ as an optional component, may be contained, in the glass constitution examples A, B and C, in an amount of at most 10%, preferably at most 5%. When it is at most 10%, the glass tends not to be devitrified.

In the glass composition of the multicomponent oxide glass to be used as the light guide plate body 11, in order to improve the melting property of glass, Fe₂O₃ may be contained in an amount of from 5 to 100 ppm. Further, the preferred range of the amount of Fe₂O₃ is the same as the above description.

Further, the multicomponent oxide glass to be used as the light guide plate body 11 may contain SO₃ used as a fining agent. In such a case, the SO₃ content is preferably more than 0% and at most 0.5%, as represented by mass percentage. It is more preferably at most 0.4%, further preferably at most 0.3%, still more preferably at most 0.25%.

Further, the multicomponent oxide glass to be used as the light guide plate body 11 may contain at least one of Sb₂O₃, SnO₂ or As₂O₃ used as an oxidizing agent and a fining agent. In such a case, the content of Sb₂O₃, SnO₂ or As₂O₃ is preferably from 0 to 0.5% as represented by mass percentage. It is more preferably at most 0.2%, further preferably at most 0.1%, and still more preferably not substantially contained.

However, Sb₂O₃, SnO₂ and As₂O₃ function as an oxidizing agent for glass, and therefore may be added within the above mentioned ranges, for the purpose of adjusting the amount of Fe²⁺ of the glass. However, As₂O₃ is not one to be positively incorporated from the viewpoint of the environment.

Further, the multicomponent oxide glass to be used as the light guide plate body 11 may contain NiO. When NiO is contained, NiO also functions as a coloring component, and therefore, the content of NiO is preferably made to be at most 10 ppm to the total amount of the glass composition as described above. In particular, NiO is, from the viewpoint of not lowering the internal transmittance in the visible light region, preferably at most 1.0 ppm, more preferably at most 0.5 ppm.

Further, the multicomponent oxide glass to be used as the light guide plate body 11 may contain Cr₂O₃. When Cr₂O₃ is contained, Cr₂O₃ also functions as a coloring component, and therefore, the content of Cr₂O₃ is preferably made to be at most 10 ppm to the total amount of the glass composition as described above. In particular, Cr₂O₃ is, from the viewpoint of not lowering the internal transmittance in the visible light region, preferably at most 1.0 ppm, more preferably at most 0.5 ppm.

Further, the multicomponent oxide glass to be used as the light guide plate body 11 may contain MnO₂. When MnO₂ is contained, MnO₂ also functions as a component which absorbs visible light, and therefore, the content of MnO₂ is preferably made to be at most 50 ppm to the total amount of the glass composition as described above. Particularly from the viewpoint of not lowering the internal transmittance in the visible light region, MnO₂ is preferably made to be at most 10 ppm.

The multicomponent oxide glass to be used as the light guide plate body 11 may contain TiO₂. When TiO₂ is contained, TiO₂ also functions as a component which absorbs visible light, and therefore, the content of TiO₂ is preferably made to be at most 1,000 ppm to the total amount of the glass composition as described above. From the viewpoint of not lowering the internal transmittance in the visible light region, the content of TiO₂ is more preferably made to be at most 500 ppm, particularly preferably made to be at most 100 ppm.

The multicomponent oxide glass to be used as the light guide plate body 11 may contain CeO₂. CeO₂ has an effect to lower the redox of iron and is capable of reducing the proportion of the amount of Fe²⁺ in terms of the amount of total irons. On the other hand, in order to suppress the redox of iron from being less than 3%, the content of CeO₂ is preferably made to be at most 1,000 ppm to the total amount of the glass composition as described above. Further, the content of CeO₂ is more preferably made to be at most 500 ppm, further preferably made to be at most 400 ppm, particularly preferably made to be at most 300 ppm, most preferably made to be at most 250 ppm.

The multicomponent oxide glass to be used as the light guide plate body 11 may contain at least one member selected from the group consisting of CoO, V₂O₅ and CuO. When these components are contained, these components will also function as components which absorb visible light, and therefore, the content of at least one member selected from the group consisting of CoO, V₂O₅ and CuO is preferably made to be at most 10 ppm to the total amount of the glass composition described above. Particularly, from the viewpoint of not lowering the internal transmittance in the visible light region, these components are preferably not substantially contained.

The thickness of the glass plate having a rectangular shape in plane view to be used as the light guide plate body 11 is not particularly restricted and may be optionally selected depending on the design of an edge light type backlight, required optical properties, etc. However, the thickness is from 0.5 to 10 mm, preferably from 1 to 5 mm, more preferably from 1.5 to 3 mm.

Here, in the thickness of the glass plate, the after-mentioned range of the plate thickness deviation (TTV) is permissible.

In the size of the glass plate having a rectangular shape in plane view to be used as the light guide plate body 11, the length of one side of the main surface of the glass plate varies depending on a liquid crystal display device using the lenticular structure of the present invention as an edge light type backlight. For example, in a case where the liquid crystal display device is a liquid crystal TV, the length of one side of the main surface of the glass plate is preferably at least 200 mm, more preferably at least 250 mm, further preferably at least 400 mm. Further, in the length of one side of the main surface of the glass plate, the difference in length between two opposing sides in the after-mentioned range is permissible.

### Lenticular Lens

The lenticular lens 12 may be formed by coating the main surface of the light guide plate body 11 with a liquid UV curable resin material or laminating a sheet state UV curable resin material on the main surface of the light guide plate body 11, followed by pressing on a roll mold, transferring a lenticular lens shape formed on the surface of the mold and then applying UV to cure in accordance with the above procedure.

Further, the lenticular lens 12 may be formed by coating the surface of a roll mold with liquid of a UV curable resin material and applying UV light from the back side of the light guide plate body 11, while attaching the main surface of the light guide plate body 11 on the coated surface.

As one constitution example of the UV curable resin material, one having a monomer having a polymerizable group may be mentioned. The monomer having a polymerizable group may, for example, be an addition-polymerizable monomer having at least one terminal ethylenic unsaturated group, and a (meth)acrylic acid, a (meth)acrylate, a (meth)acrylamide, a vinyl ether, a vinyl ester, a styrene compound, an allyl ether or an allyl ester is preferred. From the viewpoint of a curing property and transparency, a (meth)acrylate monomer is preferred. The (meth)acrylic acid is a generic name for an acrylic acid and a methacrylic acid, the (meth)acrylate is a generic name for an acrylate and a methacrylate, and the (meth)acrylamide is a generic name for an acrylamide and methacrylamide.

Further, a monomer having a cyclic ether structure such as an epoxy group, a glycidyl group, an oxetane group or an oxazoline group may be used.

The number of the polymerizable groups in the monomer having a polymerizable group is preferably from 1 to 6, more preferably 1 or 2.

As the addition-polymerizable monomer having at least one terminal ethylenic unsaturated group, a known compound having a meth(acrylate) group or an allyl group may be used. The monofunctional one may, for example, be a mono(meth)acrylate such as a phenoxyethyl (meth)acrylate, a benzyl (meth)acrylate, a stearyl (meth)acrylate, a lauryl (meth)acrylate, a 2-ethylhexyl (meth)acrylate, an ethoxyethyl (meth)acrylate, a methoxyethyl (meth)acrylate, a glycidyl (meth)acrylate, a tetrahydrofurfuryl (meth)acrylate, an allyl (meth)acrylate, a 2-hydroxyethyl (meth)acrylate, a 2-hydroxypropyl (meth)acrylate, an N,N-diethylaminoethyl (meth)acrylate, an N,N-dimethylaminoethyl (meth)acrylate, a dimethylaminoethyl (meth)acrylate, a methyladamantyl (meth)acrylate, an ethyladamantyl (meth)acrylate, a hydroxyadamantyl (meth)acrylate, an adamantyl (meth)acrylate or an isobornyl (meth)acrylate. The bifunctional one may, for example, be a di(meth)acrylate such as a 1,3-butanediol di(meth)acrylate, a 1,4-butanediol di(meth)acrylate, a 1,6-hexanediol di(meth)acrylate, a diethylene glycol di(meth)acrylate, a triethylene glycol di(meth)acrylate, a tetraethylene glycol di(meth)acrylate, a neopentylglycol di(meth)acrylate, a polyoxyethylene glycol di(meth)acrylate, a tripropyleneglycol di(meth)acrylate or a bisphenol A diglycidyl ether di(meth)acrylate. The tri or more functional one may, for example, be a tri(meth)acrylate such as a glycerol tri(meth)acrylate, a trimethylolpropane tri(meth)acrylate, a polyoxypropyltrimethylolpropane tri(meth)acrylate, a polyoxyethyltrimethylolpropane tri(meth)acrylate or a pentaerythritol tri(meth)acrylate or a (meth)acrylate having 4 or more polymerizable groups such as a dipentaerythritol hexa(meth)acrylate or a dipentaerythritol penta(meth)acrylate. Further, a multivalent isocyanate compound such as hexamethylene diisocyanate or tolylene diisocyanate and a urethane compound which is an addition reaction product with a hydroxy acrylate such as a 2-hydroxypropyl (meth)acrylate may be used.

In such a case, the urethane compound is preferably one having a polystyrene converted number average molecular weight of less than 10,000 by gel permeation chromatography (GPC).

The above-mentioned addition-polymerizable monomer having at least one terminal ethylenic unsaturated bond may be used alone, or two or more may be used in combination.

As a specific example of the vinyl ether, an alkyl vinyl ether such as ethyl vinyl ether, propyl vinyl ether, isobutyl vinyl ether, 2-ethylhexyl vinyl ether or cyclohexyl vinyl ether or a (hydroxyalkyl)vinyl such as 4-hydroxybutyl vinyl ether may be mentioned. As a specific example of the vinyl ester, vinyl acetate, vinyl propionate, (iso)vinyl butyrate, vinyl valerate, vinyl cyclohexanecarboxylate or vinyl benzoate may be mentioned.

As a specific example of the allyl ether, an alkyl allyl ether such as ethyl allyl ether, propyl allyl ether, (iso)butyl allyl ether or cyclohexyl allyl ether may be mentioned. As a specific example of the allyl ester, an alkyl allyl ester such as ethyl allyl ester, propyl allyl ester or isobutyl allyl ester may be mentioned.

The UV curable resin material contains a UV polymerization initiator in an amount of from 0.05 to 10 mass %, preferably from 0.1 to 5 mass %, particularly preferably from 0.5 to 3 mass %. When containing within the above range, monomers in the UV curable resin material are easily polymerized to form a cured product, and thereby it is not necessary to carry out an operation such as heating. Further, the residual UV polymerization initiator is not likely to impair the cured product, and coloration of a product can be suppressed.

The UV polymerization initiator is a compound which causes a radical reaction or an ionic reaction with UV irradiation.

The UV polymerization initiator may, for example, be the following UV polymerization initiators.

As UV polymerization initiators which initiates a radical reaction, an acetophenone type polymerization initiator, a benzoin type polymerization initiator, a benzophenone type polymerization initiator, a thioxanthone type polymerization initiator, an α-aminoketone type polymerization initiator, an α-hydroxyketone type polymerization initiator, an α-acyloxime ester, a benzyl-(o-ethoxycarbonyl)-α-monooxime, acylphosphine oxide, glyoxy ester, 3-ketocoumarin, 2-ethylanthraquinone, camphorquinone, tetramethylthiramsulfide, azobisisobutylonitrile, benzoyl peroxide, dialkyl peroxide, tert-butylperoxypivarate, etc. may be mentioned. From the viewpoint of the sensitivity and the compatibility, the acetophenone type polymerization initiator, the benzoin type polymerization initiator, the α-aminoketone type polymerization initiator or the benzophenone type polymerization initiator is preferred.

Further, as the UV cationic type polymerization initiator, a diazodisulfone type compound, a triphenylsulfonium type compound, a phenylsulfone type compound, a sulfonyl pyridine type compound, a triazine type compound or a diphenyliodonium compound is preferably used.

The UV curable resin material may contain an additive such as a solvent, a surfactant, a photosensitizer, a polymerization inhibitor, a resin, metal oxide fine particles, a carbon compound, metal fine particles or an another organic compound.

The content of monomers having a polymerizable group in the UV curable resin material is preferably at least 50 mass % and at most 99.95 mass %, more preferably at least 70 mass % and at most 99 mass %, based on the total mass of the UV curable resin material. From the viewpoint of being sufficiently cured, the content is preferably at least 50 mass %, however, considering blending an initiator component, another polymerization inhibitor, etc., the content is preferably at least 99.95 mass %.

In a case where the main surface of the light guide plate body 11 is coated with a liquid UV curable resin material, a method capable of coating the range of the entire surface to be coated with a uniform film thickness is preferred. For example, the coating method such as roller coating, screen printing, curtain flow, bar coating, die coating, gravure coating, micro-gravure coating, reverse coating, roll coating, flow coating, spray coating, blade coating or inkjet coating may be exemplified.

Among them, the die coating, the blade coating, the bar coating or the inkjet coating is preferred, since a large area can be easily coated particularly uniformly.

The coating film thickness of the UV curable resin material may be optional, so long as the film thickness is sufficient for forming the desired lenticular lens shape, however, the coating film thickness is preferably at least 1.2 times and at most 3 times of the theoretically required film thickness. When the coating film thickness is at least 1.2 times, the inside of a mold can be completely filled with a resin material independent of influences of a slight plate thickness deviation or warpage, and the size accuracy and the shape accuracy of the lenticular lens can be appropriately maintained. When the coating film thickness is at most 3 times, the end surface of the light guide plate body 11 is free from being stained due to a strayed resin material from an end part of a mold at the time of pressing the mold. Here, the theoretically required film thickness is represented by a ratio of the total volume which a lenticular lens to be produced occupies to the total area which the lenticular lens to be produced occupies. The lenticular lens here is, in FIG. 2, the lenticular lens 12 formed on the main surface of the glass light guide plate body 11, and in FIG. 3, the lenticular lens 12 formed on the resin layer 13.

### EXAMPLES

In the following Examples, as the light guide plate body 11, a glass substrate for a light guide plate (XCV (registered trademark), manufactured by Asahi Glass Company, Limited) was used. The light guide plate body 11 has a width of 1,200 mm, a length of 1,000 mm and a plate thickness of 2.1 mm. Glass substrates in Examples 1 to 9 are mentioned in Table 1.

TABLE 1

| Examples | 1 | 2 | 3 | 4 | 5 | 6 | 7 | 8 | 9 |
|---|---|---|---|---|---|---|---|---|---|
| TTV (mm) | 0.15 | 0.1 | 0.2 | 0.1 | 0.1 | 0.2 | 0.08 | 0.1 | 0.2 |
| Amount of | 0.6 | 0.3 | 0.5 | 0.6 | 0.2 | 0.5 | 0.6 | 0.4 | 0.5 |
| warpage (mm) | | | | | | | | | |
| Difference in length | 1.2 | 2.5 | 0.35 | 1.2 | 2.5 | 0.9 | 1.2 | 2.5 | 0.7 |
| between two | | | | | | | | | |
| opposing | | | | | | | | | |
| sides (mm) | | | | | | | | | |

In Comparative Examples, as the light guide plate body 11, the following glass plates were used.

Comparative Examples 1, 4 and 7: same glass plates as in Example 1, except that the values of the plate thickness deviation (TTV) are 0.5 mm, 0.4 mm and 0.3 mm, respectively.

Comparative Examples 2, 5 and 8: same glass plates as in Example 2, except that the amount of warpage is 0.8 mm, 0.9 mm or 0.7 mm.

Comparative Examples 3, 6 and 9: same glass plates as in Example 3, except that the difference in length between two opposing sides is 2.6 mm, 2.7 mm or 2.6 mm.

The UV curable resin material was prepared by the following procedure.

Ethoxylated(1)o-phenylphenol acrylate (trade name A-LEN-10, manufactured by Shin-Nakamura Chemical Co., Ltd.): 97 mass %, Irgacure 1173 (UV polymerization initiator, manufactured by BASF): 3 mass %

As the roll mold, a stainless engraved roll (manufactured by YURRIROLL Co., Ltd.) was used. The stainless engraved roll has a roll diameter of 250 mm and a roll width of 1,200 mm and has a surface on which a reverse shape of a lenticular lens shape having a curvature radius of 164 μm is engraved at a pitch of 254 μm (depth of 60 μm and theoretically required thickness of 41.7 μm) in a direction along the roll circumference.

A flat mold was prepared by the method of nickel electroforming a transferred product from the above-mentioned roll mold. The area size provided with the lenticular lens shape had a width of 1,200 mm, a length of 1,000 mm and a thickness of a mold of 2 mm. The reverse shape of a lenticular lens shape having a curvature radius of 164 μm was formed at a pitch of 254 μm (depth of 60 μm and theoretically required thickness of 41.7 μm) on the surface.

The surfaces of the roll mold and the flat mold were subjected to release treatment with a fluorine-based mold lubricant of OPTOOL HD-2100 (manufactured by Daikin Industries, Ltd.).

### Examples 1, 4 and 7 and Comparative Examples 1 to 3

A roll mold which rotates was coated with a UV curable resin material discharged from a slit die in a coating amount of 100 g/m², and the UV curable resin material was entirely and uniformly filled in a reverse shape of the lenticular lens shape formed on the surface of the roll mold. In accordance with the rotation of the roll mold, the applied UV curable resin material was made to be in contact with one main surface of the light guide plate body 11. UV was applied from the surface (the light guide plate body 11 side) of the opposite side from the contacting part of the roll mold at 1,200 mJ/cm² by means of a LED light source which mainly emits a wavelength of 365 nm to cure the UV curable resin material. In accordance with the rotation of the roll mold, the cured UV curable resin material was released from the mold, whereby a lenticular structure 10 having a lenticular lens 12 made of the cured product of the UV curable resin material on one main surface was obtained.

### Examples 2, 5 and 8 and Comparative Examples 4 to 6

The light guide plate body 11 was laid flat on a stage of a die coater, and a UV curable resin material was discharged from a slit die so that the discharged amount would be the average of 100 g/m² to form a coating film. A flat mold was pressed on the film under reduced pressure of at most 100 mm Torr at room temperature, followed by applying UV from the light guide plate body 11 side to cure the UV curable resin material under the same condition as in Example 1.

Then, the flat mold was released to obtain a lenticular structure 10 having a lenticular lens 12 made of the cured product of the UV curable resin material on one main surface.

### Examples 3, 6 and 9 and Comparative Examples 7 to 9

The light guide plate body 11 was laid flat on a surface plate, and an appropriate amount of a UV curable resin material was dropwise added thereto by means of a dispenser. Then, the UV curable resin material was scraped from the outermost surface of the surface plate maintained at a height of (the average thickness of the light guide plate body 11+0.10 mm) by means of a blade and spread on the light guide plate body 11. The rotating roll mold was pressed on the coating film, and UV was applied around the contact part from the light guide plate body 11 side under the same condition as in Example 1 to cure the UV curable resin material. In accordance with the rotation of the roll mold, the cured UV curable resin material was released from the mold to obtain a lenticular structure 10 having a lenticular lens 12 made of the cured product of the UV curable resin material and formed on one main surface.

### (Evaluation Method)

### Evaluation 1

In the plane of the lenticular structure 10 having a lenticular lens 12 formed, (1) whether a pattern was transferred or not was visually observed, (2) whether air was contained or not between the light guide plate body 10 and the UV curable resin material layer was visually observed, and (3) whether the lenticular lens 11 was formed at the predetermined height or not was observed by a laser microscope, were carried out. A case having no problem in all of (1), (2) and (3) is represented by ◯, and a case having a problem in any one of (1), (2) and (3) is represented by x.

### Evaluation 2

A case where stray on an end surface was visually observed is represented by x, and a case of no stray is represented by ◯.

In Examples 1 to 9, both evaluations 1 and 2 were ◯. In Comparative Examples 1, 2, 4, 5, 7 and 8, evaluation 2 was ◯, and evaluation 1 was x. In Comparative Examples 3, 6 and 9, evaluation 1 was ◯, and evaluation 2 was x.

This application is a continuation of PCT Application No. PCT/JP2016/083864, filed on Nov. 15, 2016, which is based upon and claims the benefit of priority from Japanese Patent Application No. 2015-223749 filed on Nov. 16, 2015. The contents of those applications are incorporated herein by reference in their entireties.

### REFERENCE SYMBOLS

10: lenticular structure, 11: glass light guide plate body, 12: lenticular lens, 13: resin layer

What is claimed is:

1. A lenticular structure including a lenticular lens in which a plurality of cylindrical lenses linearly extending are arranged in parallel in one direction on at least one main surface of a glass light guide plate main body having a rectangular shape in plan view, wherein the cylindrical lenses are cured products of a UV curable resin, the light guide plate body has a plate thickness deviation (TTV) value of at most 0.2 mm, the amount of curvature in each side direction of the rectangle is at most 0.6 mm, and the difference in length between two opposing sides is within 2.5 mm.

2. The lenticular structure according to claim 1, wherein on the main surface, the distance between the end surface of the lenticular lens and the closest end surface of the light guide plate body is more than 0 mm and at most 5 mm.

3. The lenticular structure according to claim 1, wherein in each arc in a vertical cross section of the lenticular lens, the variation in height relative to the main surface of the arc (Δh/hₐᵥ×100) is at most 10%, where h is the maximum height to the main surface of each arch, hₐᵥ is the average value of h, and Δh is the difference between the maximum value hₘₐₓ and the minimum value hₘᵢₙ in h.

4. The lenticular structure according to claim 2, wherein in each arc in a vertical cross section of the lenticular lens, the variation in height relative to the main surface of the arc (Δh/hₐᵥ×100) is at most 10%, where h is the maximum height to the main surface of each arch, hₐᵥ is the average value of h, and Δh is the difference between the maximum value hₘₐₓ and the minimum value hₘᵢₙ in h.
